(19) United States
(12) Patent Application Publication
(10) Pub. No.: US 2013/0007200 A1
(43) Pub. Date: Jan. 3, 2013

(54) SYSTEMS AND METHODS FOR DETERMINING AVAILABLE BANDWIDTH AND PERFORMING INITIAL STREAM SELECTION WHEN COMMENCING STREAMING USING HYPERTEXT TRANSFER PROTOCOL

(75) Inventors: Auke Sjoerd van der Schaar, Los Angeles, CA (US); Jason Braness, San Diego, CA (US); Kourosh Soroushian, San Diego, CA (US)

(73) Assignee: DivX, LLC, Santa Clara, CA (US)

(21) Appl. No.: 13/251,061

(22) Filed: Sep. 30, 2011

Related U.S. Application Data
(60) Provisional application No. 61/503,565, filed on Jun. 30, 2011.

(51) Int. Cl. G06F 15/16

(52) U.S. Cl. 709/217

(57) ABSTRACT

Systems and methods for determining available bandwidth and performing initial stream selection when commencing adaptive bitrate streaming using Hypertext Transfer Protocol (HTTP) in accordance with embodiments of the invention are disclosed. One embodiment includes performing a bandwidth probe to obtain an estimate of the available bandwidth between a playback device and a remote server, where the bandwidth probe comprises the playback device requesting blocks of data of increasing size from the remote server until the time taken to download a requested block exceeds a predetermined threshold, selecting an initial stream from said plurality of streams of encoded media that are encoded at different maximum bitrates rates using the playback device based upon the maximum bitrates of the plurality of streams and the estimated available bandwidth, and commencing streaming of encoded media by requesting portions of the encoded media from the initial streams using the playback device.

### CROSS REFERENCE TO RELATED APPLICATIONS

This application claims priority to U.S. Provisional Application Ser. No. 61/503,565, entitled “HTTP Adaptive Streaming Initial Bandwidth Detection and Stream Selection”, filed Jun. 30, 2011, the entirety of which is incorporated herein by reference.

### FIELD OF THE INVENTION

The present invention generally relates to streaming media and more specifically to selecting an initial stream from a number of streams encoded with different maximum bitrates.

### BACKGROUND

The term streaming media describes the playback of media on a playback device, where the media is stored on a server and continuously sent to the playback device over a network during playback. Typically, the playback device stores a sufficient quantity of media in a buffer at any given time during playback to prevent disruption of playback due to the playback device completing playback of all the buffered media prior to receipt of the next portion of media. Adaptive bit rate streaming or adaptive streaming involves detecting the present streaming conditions (e.g. the user's network bandwidth and CPU capacity) in real time and adjusting the quality of the streamed media accordingly. Typically, the source media is encoded at multiple bit rates and the playback device or client switches between streaming the different encodings depending on available resources. When a playback device commences adaptive bitrate streaming, the playback device typically starts by requesting portions of media from the lowest bitrate streams (where alternative streams are available). As the playback device downloads the requested media, the playback device can measure the available bandwidth. In the event that there is additional bandwidth available, the playback device can switch to higher bitrate streams.

Adaptive streaming solutions typically utilize either Hypertext Transfer Protocol (HTTP), published by the Internet Engineering Task Force and the World Wide Web Consortium as RFC 2616, or Real Time Streaming Protocol (RTSP), published by the Internet Engineering Task Force as RFC 2326, to stream media between a server and a playback device. HTTP is a stateless protocol that enables a playback device to request a byte range within a file. HTTP is described as stateless, because the server is not required to record information concerning the state of the playback device requesting information or the byte ranges requested by the playback device in order to respond to requests received from the playback device. RTSP is a network control protocol used to control streaming media servers. Playback devices issue control commands, such as “play” and “pause”, to the server streaming the media to control the playback of media files. When RTSP is utilized, the media server records the state of each client device and determines the media to stream based upon the instructions received from the client devices and the client's state.

In adaptive streaming systems, the source media is typically stored on a media server as a top level index file pointing to a number of alternate streams that contain the actual video and audio data. Each stream is typically stored in one or more container files. Different adaptive streaming solutions typically utilize different index and media containers. The Synchronized Multimedia Integration Language (SMIL) developed by the World Wide Web Consortium is utilized to create indexes in several adaptive streaming solutions including IIS Smooth Streaming developed by Microsoft Corporation of Redmond, Wash., and Flash Dynamic Streaming developed by Adobe Systems Incorporated of San Jose, Calif. HTTP Adaptive Bitrate Streaming developed by Apple Computer Incorporated of Cupertino, Calif. implements index files using an extended M3U playlist file (.M3U8), which is a text file containing a list of URIs that typically identify a media container file. The most commonly used media container formats are the MP4 container format specified in MPEG-4 Part 14 (i.e. ISO/IEC 14496-14) and the MPEG transport stream (TS) container specified in MPEG-2 Part 1 (i.e. ISO/IEC Standard 13818-1). The MP4 container format is utilized in IIS Smooth Streaming and Flash Dynamic Streaming. The TS container is used in HTTP Adaptive Bitrate Streaming.

### SUMMARY OF THE INVENTION

Systems and methods for determining available bandwidth and performing initial stream selection when commencing streaming in accordance with embodiments of the invention are disclosed. One embodiment includes performing a bandwidth probe to obtain an estimate of the available bandwidth between a playback device and a remote server, where the bandwidth probe comprises the playback device requesting blocks of data of increasing size from the remote server until the time taken to download a requested block exceeds a predetermined threshold, selecting an initial stream from said plurality of streams of encoded media that are encoded at different maximum bitrates rates using the playback device based upon the maximum bitrates of the plurality of streams and the estimated available bandwidth, and commencing streaming of encoded media by requesting portions of the encoded media from the initial streams using the playback device.

In a further embodiment, requesting blocks of data of increasing size from the remote server until the time taken to download one of the requested blocks exceeds a predetermined threshold further includes requesting an initial block of data from the remote server using the playback device, where the initial size of the block of data is determined based upon the minimum bandwidth at which streaming can be supported and a maximum probe time and determining an increased block size when the time taken to download the initial block of data does not exceed the predetermined threshold by estimating the available bandwidth based upon the size of the requested block of data, and the time taken to download the requested block of data and multiplying the estimated available bandwidth by a predetermined maximum allowable probe time.

Another embodiment also includes adjusting the estimate of the available bandwidth by a predetermined amount.

In a still further embodiment, the predetermined amount is dependent upon the value of the estimate of the available bandwidth.

Still another embodiment also includes adjusting the estimate of the available bandwidth based upon a maximum startup time.

In a yet further embodiment, an estimate of the available rate is determined as follows:

$${Rate}_{adjusted} = {Rate}_{probe} * ( \frac{{Time}_{maximum} - ( {Time}_{probe\_overhead} + \sum {Time}_{setup\_procedures} )}{{Time}_{maximum}} )$$

where
Rate_{adjusted} is the adjusted estimate of the available rate;
Rate_{probe} is the estimate of the available rate obtained using the bandwidth probe;
Timeₘₐₓᵢₘᵤₘ is the maximum startup time;
Time_{probe}_{_{—}}_{overhead} is the time taken to conduct the bandwidth probe; and
Timeₛₑₜᵤₚ_{_{—}}_{procedures} is the time taken to perform any additional start up operations.

In yet another embodiment, the initial stream is selected for use in the adaptive bitrate streaming of the encoded media.

In a further embodiment again, the initial stream is selected by initially allocating available bandwidth to streams which have no alternative and allocating the remaining bandwidth to the selection from the plurality of streams of encoded media that are encoded at different maximum bitrates rates.

Another embodiment again also includes selecting a stream from each of a number of sets of streams of encoded media that are encoded at different maximum bitrates.

A further additional embodiment, the user can instruct the playback device concerning allocation of bandwidth to at least one of the selections subject to the remaining available bandwidth.

Another additional embodiment includes a processor configured, via a client application, to request portions of files from a remote server. In addition, the client application further configures the processor to: perform a bandwidth probe to obtain an estimate of the available bandwidth between the playback device and a remote server, where the bandwidth probe comprises configuring the processor to request blocks of data of increasing size from the remote server until the time taken to download a requested blocks exceeds a predetermined threshold; select an initial stream based upon the bitrate of the streams and the estimated available bandwidth; and commence streaming of the encoded media by requesting portions of the encoded media from the initial stream.

In a still yet further embodiment, configuring the processor to request blocks of data of increasing size from the remote server until the time taken to download one of the requested blocks exceeds a predetermined threshold further comprises the client application configuring the processor to: request an initial block of date from the remote server using the playback device, where the initial size of the block of data is determined based upon the minimum bandwidth at which streaming can be supported multiplied by a maximum allowable probe time; and determine an increased block size when the time taken to download the initial block of data does not exceed the predetermined threshold by estimating the available bandwidth based upon the size of the requested block of data and the time taken to download the requested block of data and multiplying the estimated available bandwidth by the maximum probe time.

Still yet another embodiment includes the client application configuring the processor to adjust the estimate of the available bandwidth by a predetermined amount.

In still another embodiment again, the predetermined amount is dependent upon the value of the estimate of the available bandwidth.

In a still further additional embodiment, the client application further configures the playback device to adjust the estimate of the available bandwidth based upon a predetermined maximum allowable startup time.

In still another additional embodiment, the client application further configures the playback device to estimate the available rate as follows:

$${Rate}_{adjusted} = {Rate}_{probe} * ( \frac{{Time}_{maximum} - ( {Time}_{probe\_overhead} + \sum {Time}_{setup\_procedures} )}{{Time}_{maximum}} )$$

where
Rate_{adjusted} is the adjusted estimate of the available rate;
Rate_{probe} is the estimate of the available rate obtained using the bandwidth probe;
Timeₘₐₓᵢₘᵤₘ is the maximum startup time;
Time_{probe}_{_{—}}_{overhead} is the time taken to conduct the bandwidth probe; and
Timeₛₑₜᵤₚ_{_{—}}_{procedures} is the time taken to perform any additional start up operations.

In a yet further embodiment again, the initial stream is selected for use in the adaptive bitrate streaming of the encoded media.

In another further embodiment, the client application configures the processor to select the initial stream by initially allocating available bandwidth to streams for which there are not alternatives and allocating the remaining bandwidth to the selection from the plurality of streams of encoded media that are encoded at different maximum bitrates.

In still another further embodiment, the client application configures the processor to. select a stream from each of a number of sets of streams of encoded media that are encoded at different maximum bitrates.

In still yet another further embodiment, the client application configures the processor to receive user instructions concerning allocation of bandwidth to at least one of the selections subject to the remaining available bandwidth.

### BRIEF DESCRIPTION OF THE DRAWINGS

FIG. 1 is a network diagram of a media streaming system in accordance with an embodiment of the invention.

FIG. 2 is a flow chart illustrating a process for selecting one or more initial streams in accordance with an embodiment of the invention.

FIG. 3 is a flow chart illustrating a process for performing a bandwidth probe in accordance with an embodiment of the invention.

FIG. 4 is a flow chart illustrating a process for selecting one or more initial streams in accordance with an embodiment of the invention.

### DETAILED DISCLOSURE OF THE INVENTION

Turning now to the drawings, systems and methods for determining available bandwidth and performing initial stream selection when commencing streaming of media in accordance with embodiments of the invention are illustrated. In a number of embodiments, the playback device performs an initial bandwidth probe to determine available bandwidth. The bandwidth probe process attempts to determine the channel bandwidth in the shortest possible time by executing a few measured requests. In a number of embodiments, the requests are performed using Hypertext Transfer Protocol (HTTP) requests or a similar stateless or stateful protocol. The data requested during the bandwidth probe can be used in the actual streaming process, or discarded. When determining bandwidth over a network such as the Internet, which utilizes Transmission Control Protocol (TCP), the likelihood that an estimate of channel bandwidth made based upon time taken to download requested data accurately reflects the channel bandwidth increases based upon the time taken to download the requested data. The user experience can, however, be impacted by significant start up delays when performing adaptive bitrate streaming. Therefore, playback devices in accordance with a number of embodiments of the invention attempt to complete the bandwidth probe within a discrete period of time by requesting successfully larger portions of data until the requested data is of sufficient size given the available bandwidth to obtain a measurement of download time that is sufficiently large to provide a reliable estimate of the available bandwidth. Once the available bandwidth has been determined using the bandwidth probe, the estimate obtained during the bandwidth probe can be adjusted based upon a number of factors. The resulting bandwidth estimate can then be used to select between streams encoded at different maximum bitrates for commencement of conventional or adaptive bitrate streaming. Where audio and/or subtitle tracks are only available at a single bitrate, the bitrate of any audio and/or subtitle streams is subtracted from the bandwidth estimate. Where a specific stream such as (but not limited to) a video stream is selected from a number of alternative streams encoded at different maximum bitrates, a video stream is selected having a maximum bitrate equal to or less than the estimated remaining available bandwidth. Where alternative audio and video stream combinations are available, the system can default or rely on user selections to chose either a higher bitrate audio stream or a higher bitrate video stream. Bandwidth probes and processes for selecting initial streams when commencing streaming in accordance with embodiments of the invention are discussed further below.

### Streaming System Architecture

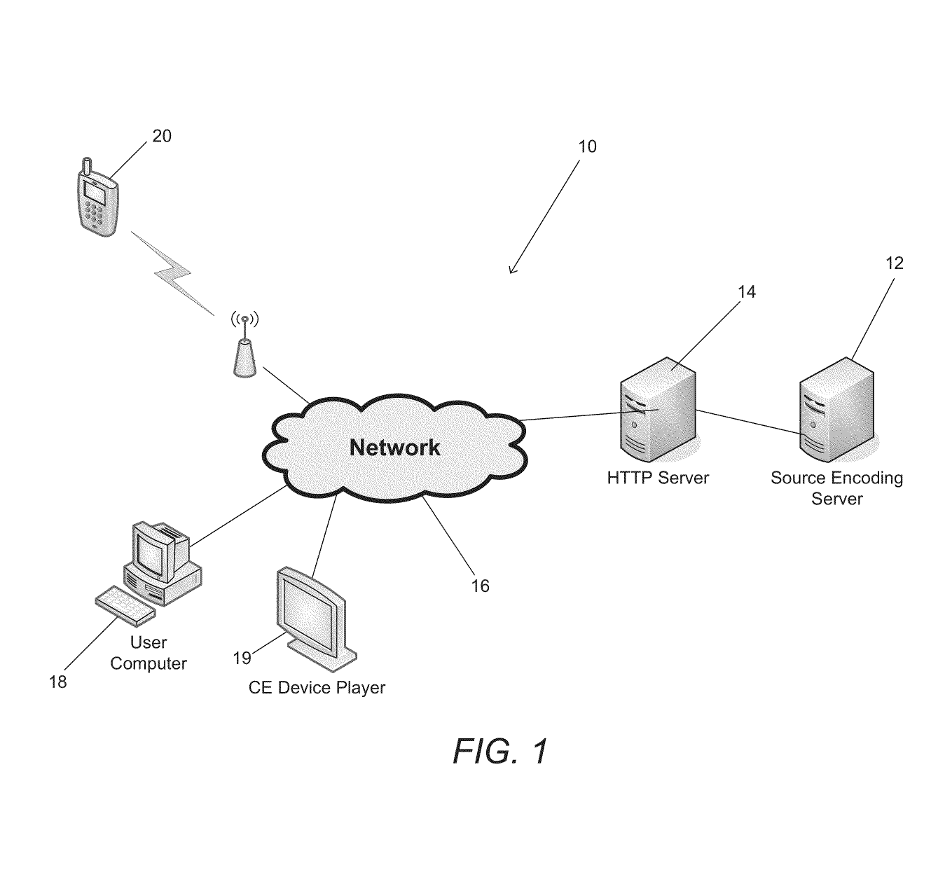

An adaptive streaming system in accordance with an embodiment of the invention is illustrated in FIG. 1. The adaptive streaming system 10 includes a source encoder 12 configured to encode source media as a number of alternative streams. In the illustrated embodiment, the source encoder is a server. In other embodiments, the source encoder can be any processing device including a processor and sufficient resources to perform the transcoding of source media (including but not limited to video, audio, and/or subtitles). As is discussed further below, the source encoding server 12 generates a top level index to a plurality of container files containing the streams, at least a plurality of which are alternative streams. Alternative streams are streams that encode the same media content in different ways. In many instances, alternative streams encode media content (such as but not limited to video) at different maximum bitrates. In a number of embodiments, the alternative streams are encoded with different resolutions and/or at different frame rates. The top level index file and the container files are uploaded to an HTTP server 14. A variety of playback devices can then use HTTP or another appropriate stateless protocol to request portions of the top level index file and the container files via a network 16 such as the Internet. Prior to a playback device performing adaptive bitrate streaming using portions of media from alternative streams contained within the container files, a bandwidth probe can be performed by the playback device to determine available bandwidth. Once the bandwidth probe has been completed, the playback device can utilize data within the top level index concerning the maximum bitrate of each of the available streams to determine the initial streams from which to commence requesting portions of encoded media as part of an adaptive bitrate streaming process.

In the illustrated embodiment, playback devices include personal computers 18, CE players, and mobile phones 20. In other embodiments, playback devices can include consumer electronics devices such as DVD players, Blu-ray players, televisions, set top boxes, video game consoles, tablets, and other devices that are capable of connecting to a server via HTTP and playing back encoded media.

Examples of adaptive bitrate streaming systems that can be utilized in accordance with embodiments of the invention include but are not limited to the adaptive bitrate streaming systems disclosed in U.S. Provisional Patent Application Ser. No. 61/430,110, “Systems and Methods For Adaptive Bitrate Streaming of Media Stored in Matroska Files Using Hypertext Transfer Protocol”, filed Jan. 5, 2011, the entirety of which is incorporated herein by reference. Although a specific architecture is shown in FIG. 1, any of a variety of architectures including systems that perform conventional streaming and not adaptive bitrate streaming can be utilized that enable playback devices to request portions of the top level index file and the container files in accordance with embodiments of the invention.

### Determining Available Bandwidth and Selecting Initial Streams

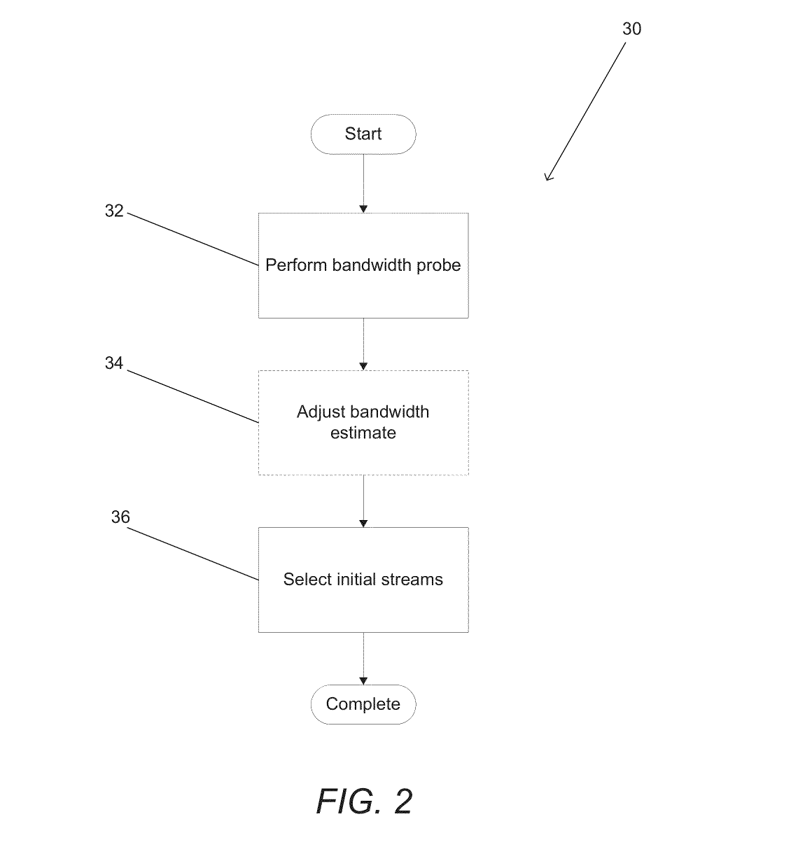

Instead of simply starting requesting the lowest bitrate stream(s), a playback device can perform an initial bandwidth probe to estimate the available bandwidth and select initial streams with which to commence streaming based upon the bandwidth estimate. A process for selecting initial stream(s) in accordance with an embodiment of the invention is illustrated in FIG. 2. The process 30 includes performing (32) a bandwidth probe, optionally adjusting (34) the bandwidth estimate, and then selecting (36) initial stream(s) based upon the (adjusted) bandwidth estimate. Bandwidth probes, the adjustment of bandwidth estimates, and the use of bandwidth estimates to select one or more initial streams when performing adaptive bitrate streaming in accordance with embodiments of the invention are discussed further below.

### Performing a Bandwidth Probe

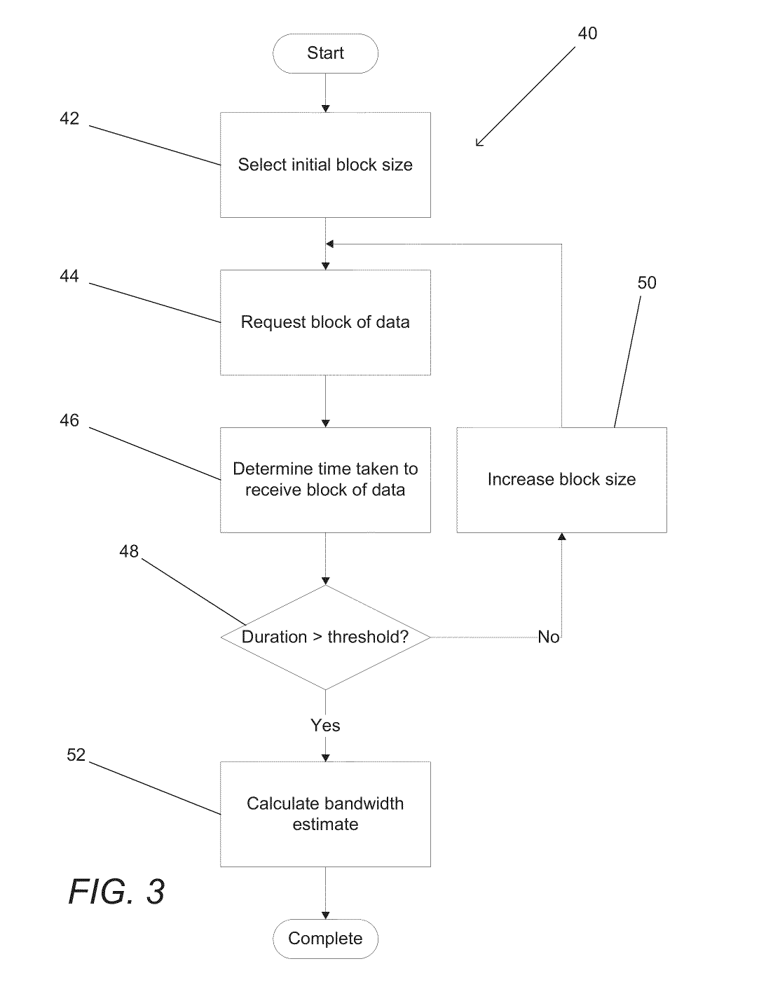

A process for performing a bandwidth probe in accordance with an embodiment of the invention is illustrated in FIG. 3. The bandwidth probe process 40 includes selecting (42) an initial block size to perform an initial probe. In many embodiments, the initial probe involves making an HTTP request that will enable a reliable bandwidth estimate in the event that the available bandwidth is comparable to the lowest bandwidth that can support playback of the encoded media. In a number of embodiments, the initial block size is determined by multiplying the minimum bitrate supported by the system by the maximum target duration for a downloading stage (e.g. 1 second). The data requested can be useful data or can be discarded. The time taken to receive the requested block is then measured (46). In the event that a determination (48) is made that the download does not take a sufficiently long period of time (e.g. a period longer than 0.5 or one-half seconds), an estimate of the channel bandwidth is performed based upon the initial measurement and a larger block size is selected based upon the estimated bandwidth. In several embodiments, a maximum download time of 1 second is used. In a number of embodiments maximum download times that are greater than or less than 1 second can be used. Increasingly larger blocks of data are requested (50) until a determination (48) is made that a sufficiently long download has been obtained. The determination is typically made based upon the requirements of a specific application and the network bandwidth conditions commonly experienced by such applications. At which point, a bandwidth estimate is calculated (52).

Although a specific bandwidth probe is discussed above with respect to FIG. 3, any of a variety of bandwidth probes can be utilized involving downloading of blocks of data of different sizes in order to obtain a download of sufficient duration to make a reliable bandwidth estimate.

### Adjusting Bandwidth Estimates

Depending upon the performance constraints of a specific playback device, a bandwidth estimate obtained by performing a bandwidth probe can be adjusted to reduce the likelihood that imprecision in the bandwidth estimation process will negatively impact playback during start up of an adaptive bitrate streaming process. In several embodiments, the estimated bandwidth is adjusted by a predetermined percentage. In a number of embodiments, the estimated bandwidth is adjusted by a predetermined percentage that is based upon the value of the estimated bandwidth. In many embodiments, the estimated bandwidth is adjusted by a constant factor. In several embodiments, a maximum starting time is defined. The bandwidth probe takes a certain amount of time as can other tasks including (but not limited to) hardware and software setup time, downloading headers and indexes from container files containing audio, video and/or subtitle streams, establishing HTTP streaming connection(s), content rights authorization and management. Given the existence of a possible maximum startup time, the playback device may adjust the estimated bandwidth so that playback commences within the time remaining following the completion of the bandwidth probe. In several embodiments, an adjusted bitrate is obtained using the following function:

$${Rate}_{adjusted} = {Rate}_{probe} * ( \frac{{Time}_{maximum} - ( {Time}_{probe\_overhead} + \sum {Time}_{setup\_procedures} )}{{Time}_{maximum}} )$$

where
Rate_{adjusted} is the adjusted estimate of the available rate;
Rate_{probe} is the estimate of the available rate obtained using the bandwidth probe (for example using the process illustrated in FIG. 3);
Timeₘₐₓᵢₘᵤₘ is the maximum startup time, which is typically determined by the requirements of a specific application;
Time_{probe}_{_{—}}_{overhead} is the time taken to conduct the bandwidth probe; and
Timeₛₑₜᵤₚ_{_{—}}_{procedures} is the time taken to perform any additional start up operations, which is also typically determined by the requirements of a specific application.

In some embodiments, the Timeₘₐₓᵢₘᵤₘ is 10 seconds. In this way, if the Timeₛₑₜᵤₚ_{_{—}}_{procedures} is 1 second and the Time_{probe}_{_{—}}_{overhead} is 2 seconds, the Rate_{probe} is multiplied by 0.7 to produce the Rate_{adjusted} in order to achieve the Timeₘₐₓᵢₘᵤₘ during the startup phase. In other embodiments, Timeₘₐₓᵢₘᵤₘ, Timeₛₑₜᵤₚ_{_{—}}_{procedures} and Time_{probe}_{_{—}}_{overhead} are determined by the requirements of the specific application.

Although specific processes are discussed above for adjusting bandwidth estimates, any adjustments appropriate to the requirements of a specific application can be utilized in accordance with embodiments of the invention.

### Selection of Initial Streams

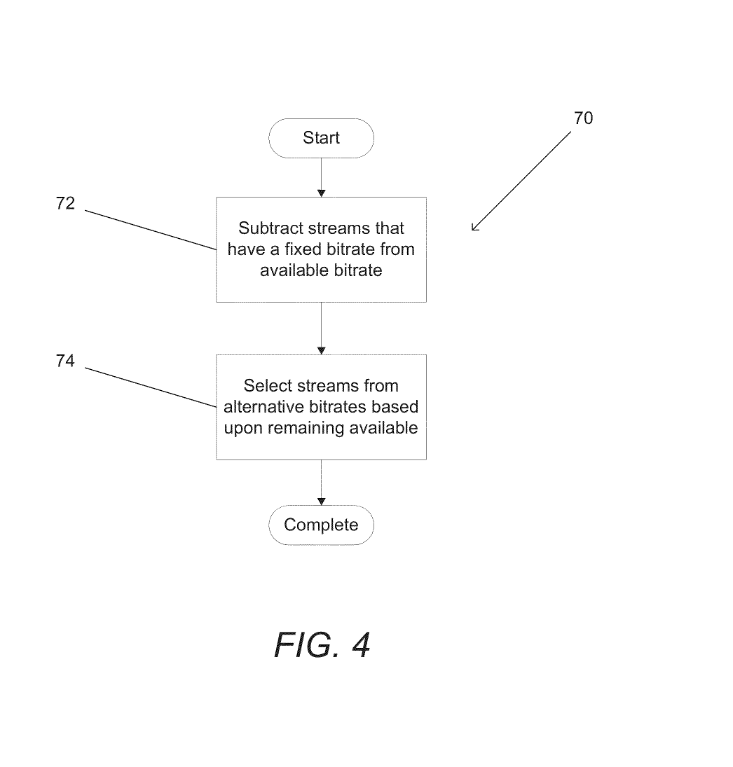

Once an estimate of the available bandwidth or bitrate has been obtained (either using the bandwidth probe or the adjusted estimate), a playback device can select one or more initial streams and commence streaming of the encoded content. A process for selecting initial stream(s) in accordance with an embodiment of the invention is illustrated in FIG. 4. When encoding content for adaptive bitrate streaming or conventional streaming at different resolutions, the source video is typically encoded as a number of alternative streams. Other portions of the source content, however, may simply be provided as a single stream (e.g. a specific audio track or a specific subtitle track). In the illustrated embodiment, the process 70 involves initially allocating bandwidth (72) to streams for which there are no alternatives. In many embodiments, bandwidth is initially allocated to streams for which there is no alternative and so the maximum bitrate is a fixed value. The total bitrate allocated to these fixed streams is then subtracted from the estimated available bitrate to obtain the remaining available bitrate for use by other streams. A selection (74) can then be made concerning alternative streams based upon the remaining available bandwidth. Where there are multiple sets of alternative streams from which selections can be made (e.g. multiple video streams encoded at different bitrates and multiple audio streams encoded at different bitrates), a tradeoff occurs between which stream will be allocated the greater share of the available bandwidth. In a number of embodiments, the playback device makes a predetermined selection. In many embodiments, the predetermined selection is made based upon the available bandwidth and the maximum bitrates of the streams within the two sets of alternative streams. In several embodiments, the user can force the selection of a higher bitrate stream (e.g. the user can chose to force the selection of a higher rate video stream or a higher rate audio stream). Once the initial streams are selected, the playback device can commence requesting portions of encoded media from the initial streams and, in adaptive bitrate systems, can adjust the stream selections based upon the streaming conditions experienced by the playback device.

Although a specific process for selecting initial streams based upon an available bandwidth estimate determined using a bandwidth probe is discussed above with respect to FIG. 4, any of a variety of processes can be utilized to select initial streams based upon a bandwidth estimate in accordance with embodiments of the invention.

Although the present invention has been described in certain specific aspects, many additional modifications and variations would be apparent to those skilled in the art. It is therefore to be understood that the present invention may be practiced otherwise than specifically described, including various changes in the implementation such as utilizing encoders and decoders that support features beyond those specified within a particular standard with which they comply, without departing from the scope and spirit of the present invention. Thus, embodiments of the present invention should be considered in all respects as illustrative and not restrictive.

What is claimed:

1. A method of selecting an initial stream of encoded media from a plurality of streams of encoded media that are encoded at different maximum bitrates rates, the method comprising:
performing a bandwidth probe to obtain an estimate of the available bandwidth between a playback device and a remote server, where the bandwidth probe comprises the playback device requesting blocks of data of increasing size from the remote server until the time taken to download a requested block exceeds a predetermined threshold;
selecting an initial stream from said plurality of streams of encoded media that are encoded at different maximum bitrates rates using the playback device based upon the maximum bitrates of the plurality of streams and the estimated available bandwidth; and
commencing streaming of encoded media by requesting portions of the encoded media from the initial streams using the playback device.

2. The method of claim 1, wherein requesting blocks of data of increasing size from the remote server until the time taken to download one of the requested blocks exceeds a predetermined threshold further comprises:
requesting an initial block of data from the remote server using the playback device, where the initial size of the block of data is determined based upon the minimum bandwidth at which streaming can be supported and a maximum probe time; and
determining an increased block size when the time taken to download the initial block of data does not exceed the predetermined threshold by estimating:
the available bandwidth based upon the size of the requested block of data; and
the time taken to download the requested block of data and multiplying the estimated available bandwidth by a predetermined maximum allowable probe time.

3. The method of claim 1, further comprising adjusting the estimate of the available bandwidth by a predetermined amount.

4. The method of claim 1, wherein the predetermined amount is dependent upon the value of the estimate of the available bandwidth.

5. The method of claim 1, further comprising adjusting the estimate of the available bandwidth based upon a maximum startup time.

6. The method of claim 5, wherein an estimate of the available rate is determined as follows:
$${Rate}_{adjusted} = {Rate}_{probe} * ( \frac{{Time}_{maximum} - ( {Time}_{probe\_overhead} + \sum {Time}_{setup\_procedures} )}{{Time}_{maximum}} )$$
where
Rate_{adjusted} is the adjusted estimate of the available rate;
Rate_{probe} is the estimate of the available rate obtained using the bandwidth probe;
Timeₘₐₓᵢₘᵤₘ is the maximum startup time;
Time_{probe}_{_{—}}_{overhead} is the time taken to conduct the bandwidth probe; and
Timeₛₑₜᵤₚ_{_{—}}_{procedures} is the time taken to perform any additional start up operations.

7. The method of claim 1, wherein the initial stream is selected for use in the adaptive bitrate streaming of the encoded media.

8. The method of claim 1, wherein the initial stream is selected by initially allocating available bandwidth to streams which have no alternative and allocating the remaining bandwidth to the selection from the plurality of streams of encoded media that are encoded at different maximum bitrates rates.

9. The method of claim 8, further comprising selecting a stream from each of a number of sets of streams of encoded media that are encoded at different maximum bitrates.

10. The method of claim 9, wherein the user can instruct the playback device concerning allocation of bandwidth to at least one of the selections subject to the remaining available bandwidth.

11. A playback device configured to perform a bandwidth probe and select an initial stream from a plurality of streams of encoded media that are encoded at different maximum bitrates, the playback device comprising:
a processor configured, via a client application, to request portions of files from a remote server;
wherein the client application further configures the processor to:
perform a bandwidth probe to obtain an estimate of the available bandwidth between the playback device and a remote server, where the bandwidth probe comprises configuring the processor to request blocks of data of increasing size from the remote server until the time taken to download a requested blocks exceeds a predetermined threshold;
select an initial stream based upon the bitrate of the streams and the estimated available bandwidth; and
commence streaming of the encoded media by requesting portions of the encoded media from the initial stream.

12. The playback device of claim 11, wherein configuring the processor to request blocks of data of increasing size from the remote server until the time taken to download one of the requested blocks exceeds a predetermined threshold further comprises the client application configuring the processor to:
request an initial block of date from the remote server using the playback device, where the initial size of the block of data is determined based upon the minimum bandwidth at which streaming can be supported multiplied by a maximum allowable probe time; and
determine an increased block size when the time taken to download the initial block of data does not exceed the predetermined threshold by estimating the available bandwidth based upon the size of the requested block of data and the time taken to download the requested block of data and multiplying the estimated available bandwidth by the maximum probe time.

13. The playback device of claim 11, further comprising the client application configuring the processor to adjust the estimate of the available bandwidth by a predetermined amount.

14. The playback device of claim 11, wherein the predetermined amount is dependent upon the value of the estimate of the available bandwidth.

15. The playback device of claim 11, wherein the client application further configures the playback device to adjust the estimate of the available bandwidth based upon a predetermined maximum allowable startup time.

16. The playback device of claim 15, wherein the client application further configures the playback device to estimate the available rate as follows:
$${Rate}_{adjusted} = {Rate}_{probe} * ( \frac{{Time}_{maximum} - ( {Time}_{probe\_overhead} + \sum {Time}_{setup\_procedures} )}{{Time}_{maximum}} )$$
where
Rate_{adjusted} is the adjusted estimate of the available rate;
Rate_{probe} is the estimate of the available rate obtained using the bandwidth probe;
Timeₘₐₓᵢₘᵤₘ is the maximum startup time;
Time_{probe}_{_{—}}_{overhead} is the time taken to conduct the bandwidth probe; and
Timeₛₑₜᵤₚ_{_{—}}_{procedures} is the time taken to perform any additional start up operations.

17. The playback device of claim 11, wherein the initial stream is selected for use in the adaptive bitrate streaming of the encoded media.

18. The playback device of claim 11, wherein the client application configures the processor to select the initial stream by initially allocating available bandwidth to streams for which there are not alternatives and allocating the remaining bandwidth to the selection from the plurality of streams of encoded media that are encoded at different maximum bitrates.

19. The playback device of claim 18, wherein the client application configures the processor to select a stream from each of a number of sets of streams of encoded media that are encoded at different maximum bitrates.

20. The playback device of claim 19, wherein the client application configures the processor to receive user instructions concerning allocation of bandwidth to at least one of the selections subject to the remaining available bandwidth.
